(19) United States
(12) Patent Application Publication
(10) Pub. No.: US 2004/0098221 A1
(43) Pub. Date: May 20, 2004

(54) Size measuring method and device

(76) Inventor: Shozo Katamachi, Mikata-shi (JP)

Correspondence Address: NIXON PEABODY, LLP, 401 9TH STREET, NW, SUITE 900, WASINGTON, DC, 20004-2128, US

(21) Appl. No.: 10/468,076

(22) PCT Filed: Feb. 7, 2002
(86) PCT No.: PCT/JP02/01023

(30) Foreign Application Priority Data
Feb. 16, 2001 (JP) 2001-40668

(51) Int. Cl. G01B 13/08

(52) U.S. Cl. 702/157

(57) ABSTRACT

A work holder (22) for holding work (W) has a porous body (34) disposed in the inner periphery thereof, and work (W) is held in the center of the work holder (22) by the centripetal action of the air spouted from the porous body (34). The work (W) held in the work holder (22) has its end surface imaged by a CCD camera (54), and according to the image of the end surface of the work project on the CCD, the eccentricity of the work (W) can be taken without rotating the work (W). Thus, a size measuring method and a device therfor can be provided which are capable of taking a simple and accurate size measurement of work by means of a simple arrangement.

### TECHNICAL FIELD

The present invention relates to a size measuring method and device, and in particular, to a size measuring method and device that measures the sizes of fine cylindrical parts such as ferrules.

### BACKGROUND ART

When a fine cylindrical part such as a ferrule has its size measured, work is place on a V table or the like and a probe of a contact measuring instrument is abutted against an inner diameter portion of the work. The work is then rotated, and the deflection from the maximum and minimum values obtained is determined. The amount obtained is then halved to obtain concentricity.

Further, if the work is measured in a non-contact manner, then as disclosed in Japanese Patent Application Publication No. 8-29642, Japanese Patent Application Publication No. 10-227619, and Japanese Patent Application Publication No. 6-174433, work is placed on a V table or the like and rotated. Then, an end surface of the work is imaged using a CCD camera. Then, image data obtained is subjected to image processing to determine an inner diameter, an outer diameter, and concentricity.

However, these conventional size measuring methods all require a mechanism that rotates the work. This disadvantageously increases the size of the device. Further, the work must be rotated during measurements, disadvantageously requiring much time for the measurements. Furthermore, since the work is rotated while placed on the V table or the like, the V table or the like may be worn over time. This may disadvantageously precludes accurate measurements. Moreover, if the work is externally partly deformed, e.g., if it externally has a depression or the like, the depression is also measured as the amount of inner diameter concentricity. This also disadvantageously hinders accurate measurements.

The present invention is provided in view of these problems. It is an object of the present invention to provide a size measuring method and apparatus that can easily and accurately measure the size of work using a simple configuration.

### SUMMARY OF THE INVENTION

In order to attain the above-described object, a first aspect of a size measuring method according to the present invention is characterized by comprising a master imaging step of inserting, into a hole formed in a work receiving member, a cylindrical master an inner diameter dimension of which is known and for which a position of its outer diameter center with respect to its inner diameter center is known, spouting air from an inner periphery toward a center of the hole to support the master in the center of the hole, and using an imaging element to image an end surface of the master supported in the work receiving member; an imaging scale calculating step of determining an imaging scale for an image projected on the imaging element from information on the known inner diameter dimension of the master according to an image of an inner diameter portion of the master projected on the imaging element; a master inner diameter center position calculating step of determining a position of the inner diameter center of the master on the imaging element according to the image of the inner diameter portion projected on the imaging element; an origin setting step of determining a position of the outer diameter center of the master on the imaging element according to information on the position of the inner diameter center of the master on the imaging element, on an imaging scale, and on the position of the outer diameter center with respect to the inner diameter center and setting the position of the outer diameter portion to be an origin on the imaging element; a work imaging step of inserting a cylindrical master to be measured into a hole formed in the work receiving member, spouting air from the inner periphery toward the center of the hole to support the work in the center of the hole, and using the imaging element to image an end surface of the work supported in the work receiving member; a work inner diameter center position calculating step of determining a position of an inner diameter center of the work on the imaging element according to an image of an inner diameter portion of the work projected on the imaging element; and a work concentricity calculating step of determining concentricity of the work according to the position of the inner diameter center of work on the imaging element and the position of the origin set on the imaging element.

According to the first aspect of the size measuring method according to the present invention, the concentricity of the cylindrical work is measured without rotating the work. Specifically, a cylindrical master an inner diameter dimension of which is known and for which a position of its outer diameter center with respect to its inner diameter center is known is inserted into a hole formed in a work receiving member. Air is spouted from an inner periphery toward a center of the hole to support the master in the center of the hole owing to the centripetal action of the air. Then, an imaging element is used to image an end surface of the master supported in the work receiving member. Then, an imaging scale for an image projected on the imaging element is determined from the information on the known inner diameter dimension of the master according to an image of an inner diameter portion of the master projected on the imaging element. Then, a position of the inner diameter center of the master on the imaging element is determined according to the image of the inner diameter portion projected on the imaging element. Then, a position of the outer diameter center of the master on the imaging element is determined according to information on the determined position of the inner diameter center of the master, on an imaging scale, and on the known position of the outer diameter center with respect to the inner diameter center of the master. The determined position of the outer diameter portion of the master is set to be an origin on the imaging element. Then, a cylindrical master to be measured is inserted into a hole formed in the work receiving member. Like the master, the work is supported in the center of the hole owing to the centripetal action of air blown from the inner periphery of the hole. The imaging element is used to image an end surface of the master supported in the work receiving member. Here, the work is supported in the center of the hole owing to the centripetal action of air blown from the inner periphery of the hole. Further, the outer diameter center of the work coincides with the position of the origin set on the imaging element. Then, a position of an inner diameter center of the work on the imaging element is determined according to an image of an inner diameter portion of the work projected on the imaging element. Then, concentricity of the work, i.e., the deflection of the inner diameter center with respect to the outer diameter center, is determined according to the determined position of the inner diameter center of work and the position of the origin set on the imaging element.

Further, to achieve the above object, a second aspect of a size measuring method according to the present invention is characterized by comprising a master imaging step of inserting a cylindrical master an inner diameter dimension of which is known, into a hole formed in a work receiving member, spouting air from an inner periphery toward a center of the hole to support the master in the center of the hole, and using an imaging element to image an end surface of the master supported in the work receiving member; an imaging scale calculating step of determining an imaging scale for an image projected on the imaging element from the information on the known inner diameter dimension of the master according to an image of an inner diameter portion of the master projected on the imaging element; a master inner diameter center position calculating step of determining a position of the inner diameter center of the master on the imaging element according to the image of the inner diameter portion projected on the imaging element; an origin setting step of determining a position of the outer diameter center of the master on the imaging element according to the imaging scale and a plurality of data on the position of the inner diameter center of the master on the imaging element obtained by repeating the master imaging step and the master inner diameter center position calculating step a number of times, and setting the position of the outer diameter portion to be an origin on the imaging element; a work imaging step of inserting a cylindrical master to be measured into a hole formed in the work receiving member, spouting air from the inner periphery toward the center of the hole to support the work in the center of the hole, and using the imaging element to image an end surface of the work supported in the work receiving member; a work inner diameter center position calculating step of determining a position of an inner diameter center of the work on the imaging element according to an image of an inner diameter portion of the work projected on the imaging element; and a work concentricity calculating step of determining concentricity of the work according to the position of the inner diameter center of work on the imaging element and the position of the origin set on the imaging element.

The second aspect of the size measuring method according to the present invention differs from the first aspect of the size measuring method according to the present invention in that the cylindrical master the inner diameter dimension of which is known is used to set the origin on the imaging element. According to the second aspect, first, a cylindrical master an inner diameter dimension of which is known is inserted into a hole formed in a work receiving member. Then, air is spouted from an inner periphery toward a center of the hole to support the master in the center of the hole. Then, an imaging element is used to image an end surface of the master supported in the work receiving member. Then, an imaging scale for an image projected on the imaging element is determined from the information on the known inner diameter dimension of the master according to an image of an inner diameter portion of the master projected on the imaging element. Then, a position of the inner diameter center of the master on the imaging element is determined according to the image of the inner diameter portion projected on the imaging element. Then, the master is rotated in a circumferential direction or is removed from the work receiving member and then inserted into it again to move the position of the inner diameter portion projected on the imaging element. Then, the imaging device is used to image the end surface of the master on which the position of the inner diameter portion has been moved. Then, the position of the inner diameter center of the master on the imaging element is determined according to an image of the inner diameter portion of the master projected on the imaging element. In this manner, the position of the inner diameter portion projected on the imaging element is moved a number of times to obtain a plurality of (at least three) data on the position of the inner diameter center. Then, a position of the outer diameter center of the master on the imaging element is determined according to the thus determined plural a plurality of data on the position of the inner diameter center and the imaging scale. That is, the master has its outer diameter center always held at a fixed position because of the centripetal action of air. Even on the imaging element, the outer diameter center is always located at a fixed position. On the other hand, the concentricity of the master is invariable. Accordingly, once a plurality of positions of the inner diameter center are determined, the position of the outer diameter center on the imaging element can be identified by determining points at equal distance from the determined positions of the inner diameter center. The position of the outer diameter center can be determined to be the center of a circle passing through the positions of the inner diameter center. Then, the thus determined position of the outer diameter center is set to be an origin on the imaging element.

Further, to achieve the above object, a third aspect of a size measuring method according to the present invention is characterized by comprising a master imaging step of inserting, into a hole formed in a work receiving member, a cylindrical master which has two indices formed on its end surface and for which a distance between the indices and a position of its outer diameter center with respect to at least one of the indices are known, spouting air from an inner periphery toward a center of the hole to support the master in the center of the hole, and using an imaging element to image an end surface of the master supported in the work receiving member; an imaging scale calculating step of determining an imaging scale for an image projected on the imaging element from the information on the known inter-index distance of the master according to an image of the indices projected on the imaging element; an origin setting step of determining a position of the outer diameter center of the master on the imaging element according to information on a position of one of the indices on the imaging element, on the imaging scale, and a position of an outer diameter center with respect to the known index, and setting the position of the outer diameter portion to be an origin on the imaging element; a work imaging step of inserting a cylindrical master to be measured into a hole formed in the work receiving member, spouting air from the inner periphery toward the center of the hole to support the work in the center of the hole, and using the imaging element to image an end surface of the work supported in the work receiving member; a work inner diameter center position calculating step of determining a position of an inner diameter center of the work on the imaging element according to an image of an inner diameter portion of the work projected on the imaging element; and a work concentricity calculating step of determining concentricity of the work according to the position of the inner diameter center of work on the imaging element and the position of the origin set on the imaging element.

The third aspect of the size measuring method according to the present invention is different from the first aspect of the size measuring method according to the present invention in that the imaging scale and origin on the imaging element are set using a cylindrical master which has two indices on its end surface and for which a distance between the indices and on a position of its outer diameter center with respect to at least one of the indices are known. In the third aspect, first, a cylindrical master which has two indices on its end surface and for which a distance between the indices and a position of its outer diameter center with respect to at least one of the indices are known is inserted into a hole formed in a work receiving member. Air is then spouted from an inner periphery toward a center of the hole to support the master in the center of the hole. Then, an imaging element is used to image an end surface of the master supported in the work receiving member. Then, an imaging scale for an image projected on the imaging element is determined from the information on the known inter-index distance of the master. Then, a position of the outer diameter center of the master on the imaging element is determined according to information on a position of one of the indices on the imaging element, on the imaging scale, and a position of an outer diameter center with respect to the known indices. That is, since the position of the outer diameter center with respect to at least one of the indices is known, provided that the position of this index can be identified, the position of the outer diameter center of the master can be identified according to the information on the known outer diameter center. Then, the thus determined position of the outer diameter portion is set to be an origin on the imaging element.

Further, to achieve the above object, a fourth aspect of a size measuring method according to the present invention is characterized by comprising a master imaging step of inserting, into a hole formed in a work receiving member, a cylindrical master which has two indices formed on its end surface and for which a distance between the indices is known, spouting air from an inner periphery toward a center of the hole to support the master in the center of the hole, and using an imaging element to image an end surface of the master supported in the work receiving member; an imaging scale calculating step of determining an imaging scale for an image projected on the imaging element from the information on the known inter-index distance of the master according to an image of the indices projected on the imaging element; a master index position calculating step of determining a position of one of the indices on the imaging element according to an image of the index projected on the imaging element; an origin setting step of determining a position of the outer diameter center of the master on the imaging element according to a plurality of data on the position of the index on the imaging element obtained by repeating the master imaging step and the master index position calculating step a number of times and the imaging scale, and setting the position of the outer diameter portion to be an origin on the imaging element; a work imaging step of inserting a cylindrical master to be measured into a hole formed in the work receiving member, spouting air from the inner periphery toward the center of the hole to support the work in the center of the hole, and using the imaging element to image an end surface of the work supported in the work receiving member; a work inner diameter center position calculating step of determining a position of an inner diameter center of the work on the imaging element according to an image of an inner diameter portion of the work projected on the imaging element; and a work concentricity calculating step of determining concentricity of the work according to the position of the inner diameter center of work on the imaging element and the position of the origin set on the imaging element.

The fourth aspect of the size measuring method according to the present invention is different from the first aspect of the size measuring method according to the present invention in that the imaging scale and origin on the imaging element are set using a cylindrical master which has two indices on its end surface and for which a distance between the indices is known. In the fourth aspect, first, a cylindrical master which has two indices on its end surface and for which a distance between the indices is known is inserted into a hole formed in a work receiving member. Air is then spouted from an inner periphery toward a center of the hole to support the master in the center of the hole. Then, an imaging element is used to image an end surface of the master supported in the work receiving member. Then, an imaging scale for an image projected on the imaging element is determined from the information on the known inter-index distance of the master according to an image of the indices projected on the imaging element. Then, the position of one of the indices on the imaging element is determined according to an image of the indices projected on the imaging element. Then, the master is rotated in a circumferential direction or is removed from the work receiving member and then inserted into it again to move the positions of the indices projected on the imaging element. Then, the imaging device is used to image the end surface of the master on which the positions of the indices have been moved. Then, the position of one of the indices on the imaging element is determined according to an image of the indices projected on the imaging element. In this manner, the positions of the indices projected on the imaging element are moved a number of times to obtain a plurality of (at least three) data on the position of one of the indices. Then, a position of the outer diameter center of the master on the imaging element is determined according to the thus determined plural a plurality of data on the position of the index and the imaging scale, and is set to as an origin on the imaging element. That is, the master has its outer diameter center always held at a fixed position because of the centripetal action of air. Even on the imaging element, the outer diameter center is always located at a fixed position. On the other hand, the distance from the index to the outer diameter center is invariable. Accordingly, once a plurality of positions of the index are determined, the position of the outer diameter center on the imaging element can be identified by determining points at equal distance from the determined indices. The position of the outer diameter center can be determined to be the center of a circle passing through the indices. Then, the thus determined position of the outer diameter center is set to be an origin on the imaging element. In this regard, at least one of the two indices has only to be determined.

Preferably, the aspects of the size measuring method according to the present invention include a work inner diameter dimension calculating step of determining the inner diameter dimension of the work according to an image of the inner diameter portion of the work projected on the imaging element.

Further, preferably, the aspects of the size measuring method according to the present invention include a mater backpressure/flow rate measuring step of measuring a backpressure or flow rate of air spouted from the inner periphery of the hole in the work receiving member when the master is inserted, a work backpressure/flow rate measuring step of measuring a backpressure or flow rate of air spouted from the inner periphery of the hole in the work receiving member when the work is inserted, and a work outer diameter dimension calculating step of determining an outer diameter of the work according to the backpressure or flow rate of air spouted from the inner periphery of the hole in the work receiving member when the master is inserted, the backpressure or flow rate of air spouted from the inner periphery of the hole in the work receiving member when the work is inserted, and the known outer diameter dimension of the master.

According to the present invention, the outer diameter of the work is measured while the work is being supported. The outer diameter is measured utilizing the principle of what is called an “air micrometer”. Thus, the outer diameter is measured while the work is being held.

### BRIEF DESCRIPTION OF THE DRAWINGS

FIG. 1 is a block diagram schematically showing a configuration of a size measuring device according to an embodiment;

FIG. 2 is a block diagram schematically showing a configuration of a work receiving section and a feeding and collecting section;

FIG. 3 is an explanatory drawing for a master;

FIG. 4 is an explanatory drawing for an origin setting method;

FIG. 5 is an explanatory drawing for a work size measuring method;

FIG. 6 is a block diagram schematically showing a configuration of an outer diameter measuring section;

FIG. 7 is a front sectional view showing a configuration of a work holder according to a second embodiment;

FIG. 8 is an explanatory drawing for an origin setting method according to a third embodiment;

FIGS. 9(a), 9(b), and 9(c) are explanatory drawings for the origin setting method according to the third embodiment;

FIG. 10 is an explanatory drawing for the origin setting method according to the third embodiment;

FIG. 11 is an explanatory drawing for a master according to a fourth embodiment;

FIG. 12 is an explanatory drawing for an origin setting method according to the fourth embodiment;

FIG. 13 is an explanatory drawing for a master according to a fifth embodiment;

FIGS. 14(a), 14(b), and 14(c) are explanatory drawings for an origin setting method according to the fifth embodiment; and

FIG. 15 is an explanatory drawing for an origin setting method according to the fifth embodiment.

### THE PREFERRED EMBODIMENTS FOR CARRYING OUT THE INVENTION

With reference to the accompanying drawings, description will be given of preferred embodiments of a size measuring method and device according to the present invention.

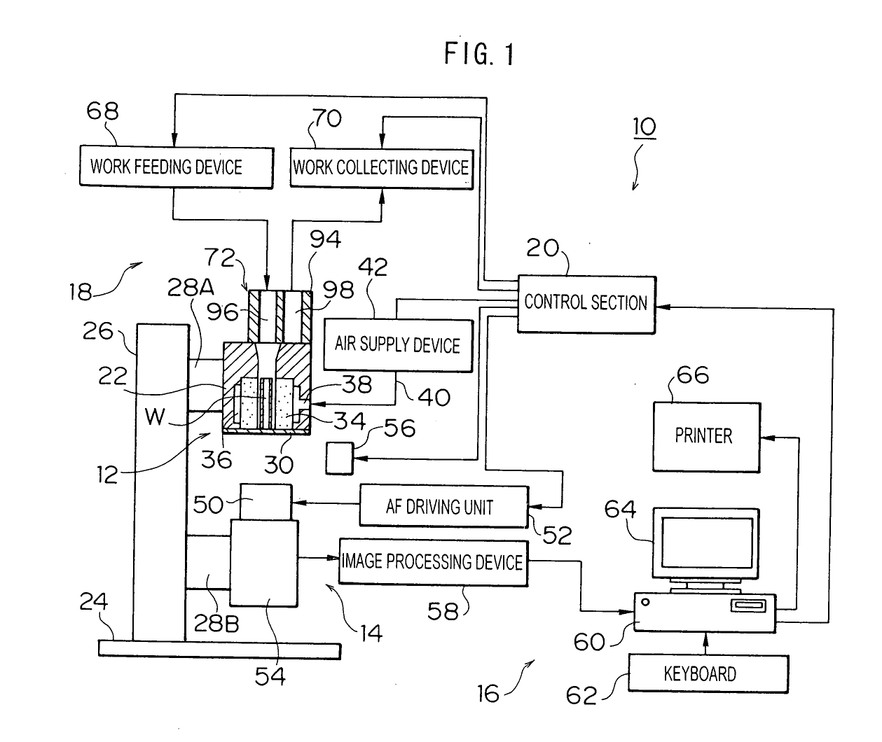

FIG. 1 is a block diagram schematically showing a configuration of a first embodiment of a size measuring device according to the present invention. As shown in this drawing, a size measuring device 10 according to the present embodiment is mainly composed of a work receiving section 12, an imaging section 14, a measuring section 16, a work feeding and collecting section 18, and a control section 20.

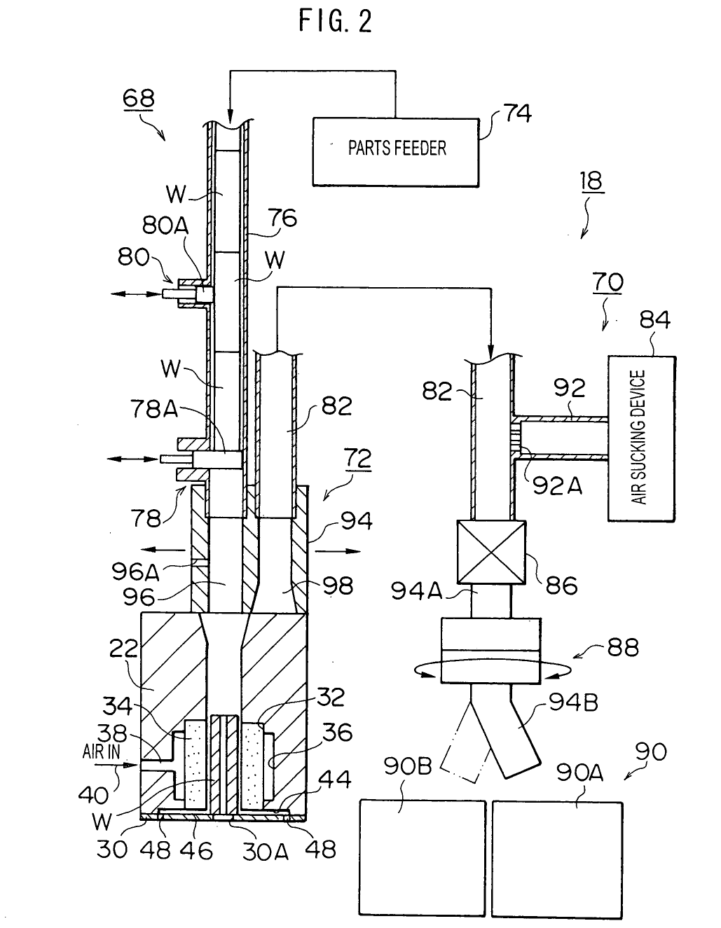

As shown in FIGS. 1 and 2, the work receiving section 12 comprises a work holder 22 used to hold a master M or work to be measured at a predetermined position. The work holder 22 is cylindrically formed and is vertically supported via a bracket 28A to a strut 26 extending vertically from a base 24. The work W to be measured is inserted into the inner periphery of the work holder 22 and supported there. Hence, a stopper plate 30 is attached to a lower end surface of the work holder 22 to prevent the inserted work W from falling. The stopper plate 30 is formed like a circular plate having a circular observation window 30A in its center. The work W inserted into the work holder 22 has its lower end locked on the stopper plate 30 and is thus prevented from falling.

Further, a fit-in hole 32 of a predetermined diameter is formed in the inner periphery of the work holder 22 so as to extend from the lower end to center of the work holder 22. A cylindrically formed porous body (sintered metal) 34 is fitted into the fit-in hole 32. An air supply channel 36 of a predetermined width is formed in the inner periphery of the fit-in hole 32 all over the circumference of the porous body 34. An air supply passage 38 is in communication with the air supply channel 36 and leads to the outer periphery of the work holder 22. An air supply device 42 is connected to the air supply passage 38 via an air supply line 40. The air supply device 42 supplies compressed air. The compressed air supplied by the air supply device 42 is supplied to the air supply channel 36 via the air supply line 40 and the air supply passage 38. The compressed air supplied to the air supply channel 36 is spouted to the inner periphery of the work holder 22 via the porous body 34. At this time, the compressed air is spouted from the entire inner periphery of the porous body 34 to inner peripheral center of the work holder 22. The centripetal action of the compressed air causes the work W inserted into the work holder to be held in the inner peripheral center of the work holder 22.

A recess 44 is formed in the lower end surface of the work holder 22 down to a predetermined depth. A predetermined gap 46 is formed between the recess 44 and the stopper plate 30. Further, vents 48, 48, . . . are formed in the stopper plate 30 so as to lead to the gap 46. The compressed air spouted into the work holder 22 is exhausted to the exterior via the vents 48, 48, . . .

The imaging section 14 uses a CCD to image an end surface of the master M and work W held in the work holder 22. The imaging section 14 is composed of an AF lens unit 50, an AF driving unit 52, a CCD camera 54, and an illuminating unit 56.

The AF lens unit 50 is installed at a predetermined distance below the work holder 22. Further, the AF lens unit 50 is installed opposite the end surface of the work W or master M held in the work holder 22. An optical axis of the AF lens unit 50 is orthogonal to the end surface of the work W or master M held in the work holder 22.

The AF driving unit 52 subjects the AF lens unit 50 to AF driving to focus it on the end surface of the work W or master M held in the work holder 22. The AF driving unit 52 comprises a distance measuring sensor (not shown). Thus, the AF lens unit 50 is subjected to AF driving according to distance measurement information on the distance to the end surface of the master M or work W.

The CCD camera 54 is supported via the bracket 28B to the strut 26 extending vertically from the base 24. The AF lens unit 50 is attached to the CCD camera 54. Accordingly, the CCD, contained in the CCD camera 54, picks up an image of the end surface of the master M or work W enlarged by the AF lens unit 50.

The illuminating unit 56 applies illuminating light to the end surface of the master M or work W held in the work holder 22.

The measuring section 16 is mainly composed of an image processing device 58 and an arithmetic processing device 60. The image processing device 58 processes data on the image of the end surface of the master M or work W imaged by the CCD camera 54 and outputs the processed data to the arithmetic processing device 60. According to the image-processed data, the arithmetic processing device 60 determines the eccentricity of the work. A keyboard 62 is connected to the arithmetic processing device 60 as an input device. A display 64 and a printer 66 are also connected to the arithmetic processing device 60 as output devices. Further, the arithmetic processing device 60 contains a memory (not shown) that stores predetermined data.

The work feeding and collecting section 18 feeds and collects the work W. The work feeding and collecting section 18 is composed of a work feeding section 68, a work collecting section 70, and switching device 72 as shown in FIGS. 1 and 2.

The work feeding device 68 feeds works W to be measured to the work holder 22 one by one. As shown in FIG. 2, the work feeding device 68 is composed of a parts feeder 74, a feed pipe 76, a shutter 78, and a stopper 80.

The parts feeder 74 is connected to the feed pipe 76 to feed sequentially works W housed in a stocker (not shown), to the feed pipe 76.

The feed pipe 76 is connected to the switching device 72 to guide the work W fed by the parts feeder 74, to the switching device 72.

The shutter 78 is installed close to the tip of the feed pipe 76 to block the passage of the work W through the feed pipe 76. The shutter 78 blocks the passage of the work W by using a cylinder (not shown) to project the shutter plate 78A into the feed pipe 76 so that the shutter plate 78A blocks up the feed pipe 76. That is, when the shutter plate 78A is projected into the feed pipe 76, the work W is locked by the shutter plate 78A and hindered from passing to the switching device 72. When the shutter plate 78A is retreated from the feed pipe 76, the work W can freely pass through the pipe 76. When the shutter plate 78A is projected into the feed pipe 76, it completely blocks up the feed pipe 76 and seals it.

The stopper 80 is installed above the shutter 78 to regulate the movement (falling) of the work W as soon as the work W has been locked by the shutter 78. Specifically, although works W must be fed to the work holder 22 one by one, when the shutter 78 is opened, all the works M in the feed pipe 76 are fed to the work holder 22. To regulate this, the stopper 80 is provided. A cylinder (not shown) is used to project a stopper member 80A of the stopper 80 into the feed pipe 76. Thus, the stopper member 80A presses and fixes the work W against and to the inner wall surface of the feed pipe 76.

With the work feeding device 68 configured as described above, when the parts feeder 74 feeds the work W to the feed pipe 76 while the shutter 78 is closed, the work W is blocked by the shutter 78 and stopped from being fed to the switching device 72. In this state, when the stopper 80 is activated, it fixes the work W following the leading work W blocked by the shutter 78. After the stopper 80 has fixed the work W, the shutter 78 is opened to feed only the leading work to the switching device 72 through the shutter 78. After the work W has been fed, the shutter 78 is closed and the fixation by the stopper 80 is cleared to feed the work W to the shutter 78. Then, the stopper 80 fixes the work following the leading work W. The work feeding device 68 then stands by until the next feeding operation.

The work collecting device 70 collects measured works W from the work holder 22 and classifies them in accordance with the results of the measurement. As shown in FIG. 2, the work collecting device 70 is composed of a collection pipe 82, an air sucking device 84, a gate 86, a directing device 88, and a collecting stocker 90.

The collection pipe 82 is connected to the switching device 72 to guide measured works W to the gate 86 via the switching device 72.

The air sucking device 84 is connected to the collection pipe 82 near the gate 86 via a suction pipe 92 to suck air from inside the collection pipe 82 via the suction pipe 92. The air sucking device 84 sucks air from inside the collection pipe 82 to suck the work W housed in the work holder 22, via the switching device 72. The work W is thus guided to the gate 86. An inflow preventing plate 92A formed like a mesh is installed at the connection between the suction pipe 92 and the collection pipe 82. The inflow preventing plate 92A prevents the work W passing through the collection pipe 82 from being mistakenly sucked into the suction pipe 92.

The gate 86 is formed to be freely opened and closed. The gate 86 blocks the work W collected by the collection pipe 82 before the work W reaches the directing device 88.

The directing device 88 is connected to the gate 86 to direct works W to respective destinations according to the results of measurements carried out by the measuring section 16. Specifically, the works W are divided into “OK works” that meet a reference value and “NG works” that do not meet the reference value, according to the results of the measurements. The works W are thus divided and collected in an OK stocker 90A and an NG stocker 90B, respectively, of the collecting stocker 90.

The directing device 88 directs the works W to the OK stocker 90A and the NG stocker 90B, respectively, by using a turn driving means (not shown) to turn a turning pipe 94B provided at the tip of a conduit 94A.

According to the work collecting device 70 configured as described above, when the air sucking device 84 is driven while the gate 86 is closed, a work W from the work holder 22 is sucked into the collection pipe 82 through the switching device 72. The sucked work W is guided to the gate 86 through the collection pipe 82. On the result of measurement of the collected work W, the directing device 98 directs the tip of the turning pipe 94B to the OK stocker 90A if the work is OK. On the other hand, the directing device 98 directs he tip of the turning pipe 94B to the NG stocker 90B if the work is NG Then, after the turning pipe 94B has been turned, the gate 86 is opened to guide the work W to the turning pipe 94B. The work W is then collected in the OK stocker 90A or the NG stocker 90B.

The switching device 72 selectively connects the work holder 22 to the feed pipe 76 and to the collection pipe 82. The switching device 72 comprises a slide block 94 as shown in FIG. 2. The slide block 94 is provided so as to slide freely across the top surface of the work holder 22. The slide block 94 is driven by driving means (not shown) to reciprocate between a “feed position” and a “collection position”. Further, the slide block is formed with a supply passage 96 and a collection passage 98. The supply passage 96 and collection passage 98 are connected to the feed pipe 76 of the work feeding device 68 and to the collection pipe 82 of the work collecting device 70, respectively.

According to the switching device 72 configured as described above, when the slide block 94 is placed at the “feed position”, the inner periphery of the work holder 22 and the feed passage 96 communicate with each other. Then, the work feeding device 68 can feed the work W to the work holder 22. On the other hand, when the slide block 94 is placed at the “collection position”, the inner periphery of the work holder 22 and the collection passage 98 communicate with each other. Then, the work W from the work holder 22 can be collected in the work collecting device 70.

The work W or master M is held so as to maintain a gap of 20 μm to 50 μm between itself and the inner periphery of the work holder 22.

Further, the work W or master M has an inner diameter of φ0.5 mm to 1 mm, which does not inconvenience an air sucking operation during work collection.

The feed pipe 96 is formed with a vent 96A of a small diameter via which compressed air supplied to the inner periphery of the work holder 22 is partly exhausted.

The control section 20 controls the individual devices constituting the size measuring device 10 according to control signals from the arithmetic processing device 60.

Now, description will be given of a work size measuring procedure executed by the size measuring device 10 configured as described previously as well as a measurement principle.

First, initial settings are made. First, the work feeding device 68 is used to feed a master M to the work holder 22. The master M supplied to the work holder 22 falls owing to its own weight. The tip of the master M is locked on the stopper plate 30. After the master M has been fed, the air supply device 42 is driven to supply compressed air to the air supply passage 38 of the work holder 22. The supplied compressed air is spouted from the entire inner periphery to inner peripheral center of the work holder 22 via the porous body 34. This centripetal action holds the master M in the inner peripheral center of the work holder 22.

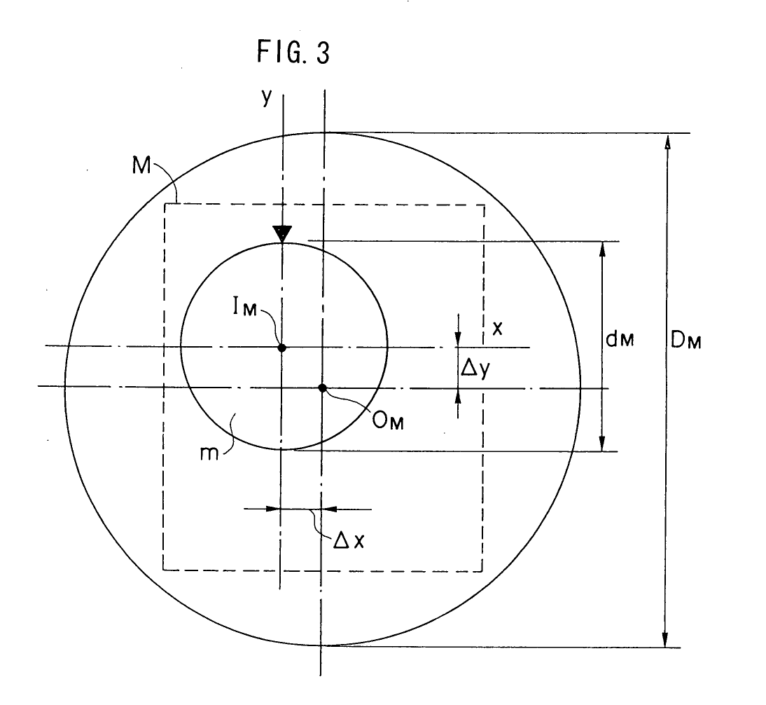

For the master M fed to the work holder 22, as shown in FIG. 3, predetermined size data has already been obtained, i.e., an outer diameter dimension D_{M}, an inner diameter dimension d_{M}, and the position of an outer diameter center O_{M} with respect to an inner diameter center I_{M} have already been measured (in the present embodiment, the outer diameter dimension D_{M} is not always necessary).

The position of the outer diameter center O_{M} with respect to the inner diameter center I_{M} is obtained by setting x-y coordinates on the end surface of the master M using the inner diameter center I_{M} as a coordinate center (0, 0) and determining a coordinate position O_{M} (Δx, Δy) on the x-y coordinates. Further, a mark (here, a black triangular mark ▾) indicating the direction of a y axis for the set x-y coordinates is provided on the end surface of the master M.

Simultaneously with the feeding of the master M, the operator inputs the known size data D_{M}, d_{M}, and O_{M}(Δx, Δy) on the master from the keyboard 62. The inputted size data is stored in a memory contained in the arithmetic processing device 60.

When the predetermined size data is inputted, predetermined measurements are executed on the master M. Specifically, first, the control section 20 outputs a drive signal to the illuminating unit 56 to irradiate the end surface of the master M with illumination light. Further, the control section 20 outputs a drive signal to the AF driving unit 52 to subject the AF lens unit 50 to AF driving. Specifically, the AF lens unit 50 is subjected to AF driving so as to focus on the end surface of the master M held in the work holder 22. Then, the CCD camera 54 images the focused end surface of the master M.

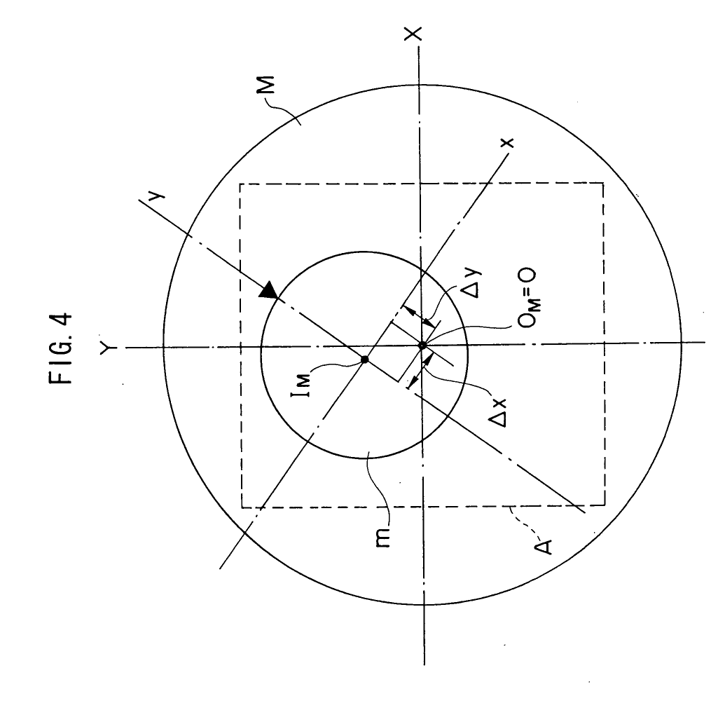

In this case, as shown in FIG. 4, a rectangular area A containing an inner diameter portion m of the master M is projected on the CCD of the CCD camera 54. The image processing device 58 executes image processing to determine an imaging scale Z for the image projected on the CCD according to an image of the inner diameter portion m of the master M projected on the CCD of the CCD camera 54 and the known inner diameter dimension d_{M} of the master M. The determined imaging scale Z is stored in the memory contained in the arithmetic processing device 60 as a constant.

Further, the image processing device 58 executes image processing to determine the position I_{M} of the inner diameter center of the master M on the CCD according to the image of the inner diameter portion m of the master M projected on the CCD.

Furthermore, as shown in FIG. 4, the image processing device 58 executes image processing to determine the direction of the y axis for the x-y coordinates set on the end surface of the master M, from the position of the mark (▾) projected on the CCD and indicating the direction of the y axis. The image processing device 58 also executes image processing to determine the direction (passing through the position I_{M} of the inner diameter center of the master M and extending perpendicular to the y axis) of an x axis from the position I_{M} of the inner diameter center of the master M. That is, the image processing device 58 executes image processing to determine the position of the x-y coordinates on the CCD which are set on the end surface of the master M.

Then, the image processing device 58 executes image processing to determine the position of the outer diameter center O_{M} of the master M on the CCD using the determined x-y coordinates on the CCD and according to the position I_{M} of the inner diameter center of the master M on the CCD, the imaging scale Z, and the known size data (the position of the outer diameter center O_{M} with respect to the inner diameter center I_{M}). Specifically, the x-y coordinates are set using the outer diameter center I_{M} of the master M as a coordinate center (0, 0), and the coordinate center O_{M}(Δx, Δy) of the outer diameter center O_{M} of the master M on the x-y coordinates is known. Thus, the image processing device 58 executes image processing to determine the position of the outer diameter center O_{M} of the master M on the CCD using the determined x-y coordinates on the CCD and according to the position I_{M} of the inner diameter center of the master M determined by image processing, the known size data (the position of the outer diameter center O_{M} with respect to the inner diameter center I_{M}), and the imaging scale Z. Then, the image processing device 58 sets X-Y coordinates (measurement coordinate system) on the CCD for which the determined position of the outer diameter center O_{M} of the master M is used as an origin O (0, 0).

The initial settings are thus completed. Once the initial settings are completed, the work collecting device 70 is used to collect the master M from the work holder 22. Then, comparative measurements are sequentially made using the master M as a reference.

First, the control section 20 outputs a drive signal to the work feeding device 68 to feed a work W to the work holder 22. Specifically, the shutter 78 is opened to feed works W to be measured to the inner periphery of the work holder 22 one by one. At this time, the slide block 94 of the switching device 72 is placed at the feed position. Accordingly, the feed pipe 76 of the work feeding device 68 is connected to the work holder 22.

The work W supplied to the work holder 22 from the shutter 78 falls owing to its own weight. The tip of the work W is locked on the stopper plate 30. After the work W has been fed, the air supply device 42 is driven to supply compressed air to the air supply passage 38 of the work holder 22. The supplied compressed air is spouted from the entire inner periphery to inner peripheral center of the work holder 22 via the porous body 34. This centripetal action holds the work W in the inner peripheral center of the work holder 22.

Since the centripetal action of the air holds the work W in the work holder 22, the work W has its outer diameter center O_{W} placed at the same position as that of the outer diameter center O_{M} of the master M. That is, the work W held by the work holder 22 always has its outer diameter center O_{W} coincide with the outer diameter center O_{M} of the master M.

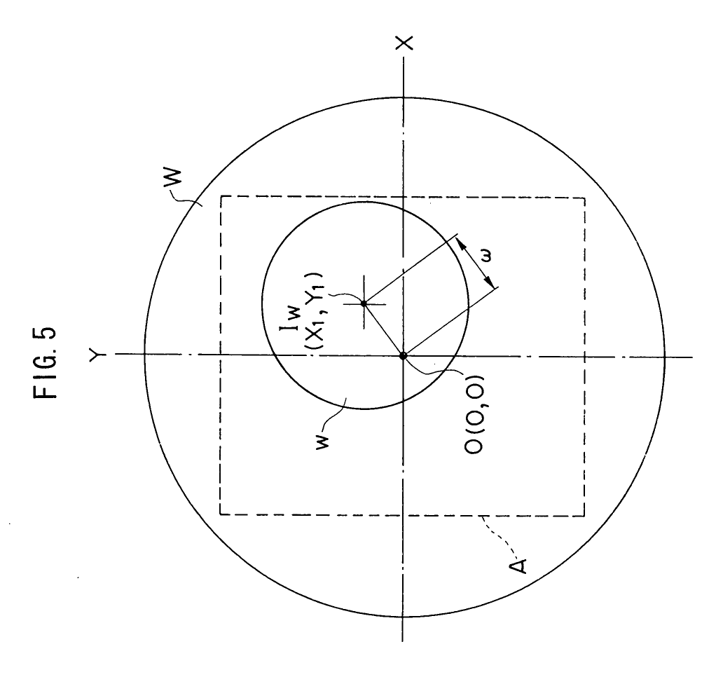

Then, as shown in FIG. 5, the CCD camera 54 images the end surface of the work W held on the work holder 22. According to an image of an inner diameter portion w of the work W projected on the CCD of the CCD camera 54, the image processing device 58 executes image processing to determine the coordinate position (X_{I}, Y_{I}) of the inner diameter center I_{W} of the work W on the X-Y coordinates (measurement coordinates).

In this case, as described above, the work W is held in the center of the work holder 22, with the outer diameter center O_{W} of the work W placed at the same position as that of the outer diameter center O_{M} of the master M. Since the outer diameter center OM of the master M is set at the origin O (0, 0) on the X-Y coordinates (measurement coordinates), the eccentricity ω of the work W, i.e., the difference between the inner diameter center I_{W} and the outer diameter center O_{W}, can be determined by finding the distance (=(X_{I}²+Y_{I}²)^{1/2}) between the origin O and the determined inner diameter center I_{W}.

The image processing device 58 calculates the eccentricity ω according to the determined coordinate position (X_{I}, Y_{I}) of the inner diameter center I_{W} of the work W and the coordinate position (0, 0) of the origin O.

Thus, the size of the work W is completely measured. The measured size data, i.e., the eccentricity ω of the work W, is displayed on the display 64 and also printed out by the printer 66 as required.

Further, when the measurements are finished, the control section 20 outputs drive signals to the switching device 72 and the work collecting device 70. The work W is classified and collected in the collecting stocker 90 according to the size data on the work W. Specifically, first, the slide block 94 of the switching device 72 is moved to the collection position to allow the collection passage 98 and the inner periphery of the work holder 22 to communicate with each other. Then, the air suction device 84 is driven to suck the work W from the work holder 22 through the collection passage 98 of the slide block 94 into the collection pipe 82. The work W is then guided to the gate 86. Then, the directing device 88 is driven according to the results of measurements of the work W. If the work W is OK, the tip of the turning pipe 94B is directed to the OK stocker 90A. On the other hand, if the work W is NG, the tip of the turning pipe 94B is directed to the NG stocker 90B. After the turning pipe 94B has been turned, the gate 86 is opened to guide the work W to the turning pipe 94B to collect the work W in the OK stocker 90A or the NG stocker 90B.

Once the work W is collected in the collecting stocker 90, a drive signal is outputted to the switching device 72 again. The slide block 94 of the switching device 72 is then moved to the feed position to allow the feed passage 96 and the inner periphery of the work holder 22 to communicate with each other. Then, the work feeding device 68 feeds a new work W to the work holder 22. The new work W is then similarly measured and collected.

Thus, according to the size measuring device 10 of the present embodiment, the work W can be fully automatically fed, measured, and collected. Further, during measurements, the work W need not be rotated or moved. This eliminates the needs for a rotating mechanism or a moving mechanism for the work W. Therefore, the device can have a simple and compact configuration. Further, since it is unnecessary to rotate or move the work W, the work W can be measured easily and promptly. Furthermore, the work W is held in the work holder 22 in a non-contact manner. Consequently, the work W is not worn over time and can always be measured stably accurately. Further, even if the outer periphery of the work W is locally deformed, possible adverse effects can be eliminated to enable the work W to be always supported in the center of the work holder 22. Therefore, the work W can always be measured accurately.

In the present embodiment, the ▾ mark is formed on the end surface of the master M as means for identifying the direction of the y axis for the x-y coordinates set on the end surface of the master M. The method for identifying the direction of the y axis is not limited to this aspect. A different mark or the like may be used for the identification.

Now, description will be given of a second embodiment of a size measuring device according to the present invention.

The size measuring device 10 according to the first embodiment, described above, measures only the eccentricity of the work W. However, the size measuring device according to the present embodiment measures the inner diameter dimension d_{W}, outer diameter dimension D_{W}, and eccentricity ω of the work W. The size measuring device according to the second embodiment is composed of the size measuring device according to the first embodiment to which an outer diameter measuring section 100 is added.

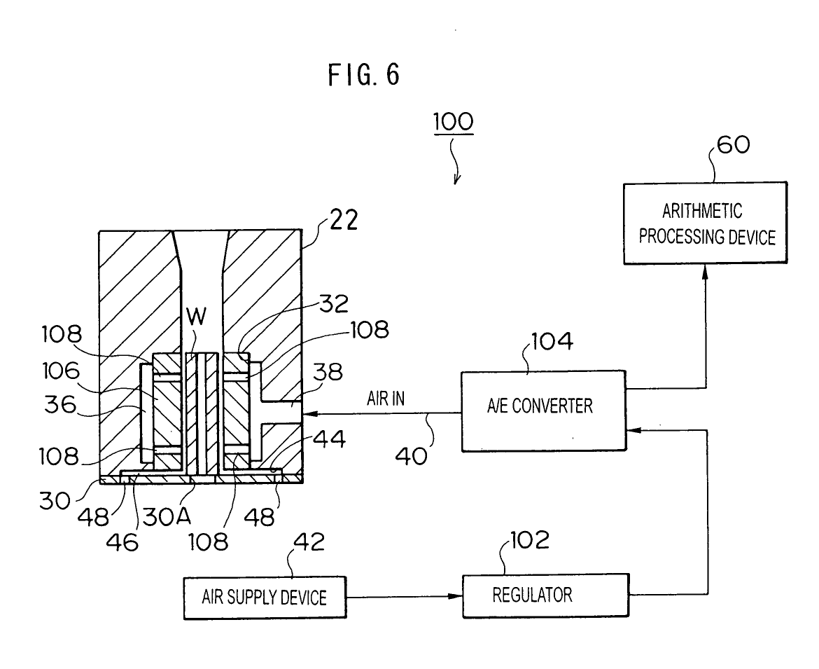

FIG. 6 is a block diagram schematically showing a configuration of the outer diameter measuring section 100. A shown in this drawing, the outer diameter measuring section 100 utilizes the principle of an air micrometer to measure the outer diameter dimension D_{W} of the work W. Compressed air supplied by the air supply device 42 is supplied to the work holder 22 via a regulator 102 and an A/E converter 104. The regulator 102 sets the pressure of the compressed air supplied by the air supply device 42, at a fixed value. The A/E converter 104 uses its built-in bellows and differential transformer to convert a change in the backpressure of the compressed air spouted from the inner periphery of the work holder 22 into an electric signal. The A/E converter 104 then outputs this electric signal to the arithmetic processing device 60. According to this electric signal, the arithmetic processing device 60 calculates the outer diameter dimension of the work W.

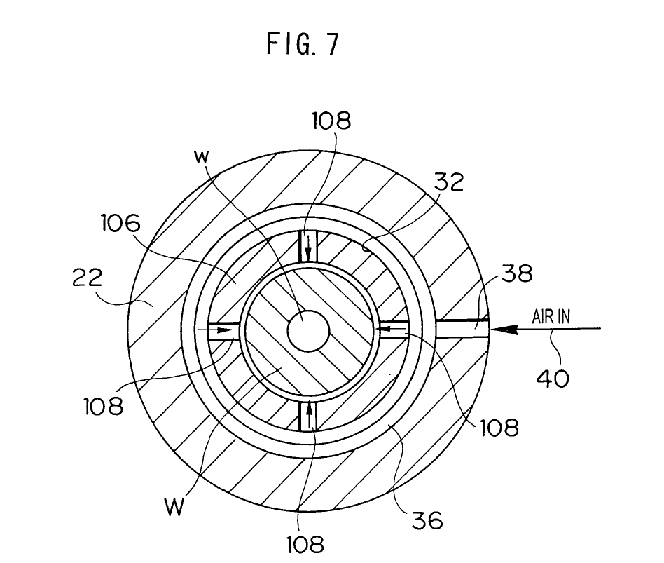

In this case, as shown in FIG. 6, a nozzle member 106 is arranged in the inner periphery of the work holder 22 according to the present embodiment in place of the porous body 34. The nozzle member 106 is, as shown in FIG. 7, cylindrically formed and has nozzles 108, 108, . . . formed in its peripheral surface at four locations at equal intervals.

Compressed air supplied to the air supply passage 38 is supplied to the nozzles 108, 108, . . . via the air supply channel 36. The compressed air is then spouted from the nozzles 108, 108, . . . to the inner peripheral center of the work holder 22. The work W inserted into the work holder is held in the inner peripheral center of the work holder 22 owing to the centripetal action of the air spouted from the nozzles 108, 108, . . . Further, the outer diameter dimension D_{W} of the work W is measured according to a change in pressure (backpressure) between the nozzles 108, 108, . . . and a diaphragm contained in the A/E converter 104.

As described above, the outer diameter dimension D_{W} of the work W is measured according to a change in the backpressure of the compressed air spouted from the inner periphery of the work holder 22.

On the other hand, the image processing device 58 determines the inner diameter dimension d_{W} of the work according to an image of the inner diameter portion w of the work W projected on the CCD of the CCD camera 54 and the imaging scale Z.

Now, description will be given of a work size measuring method executed by the size measuring device of the second embodiment configured as described previously.

First, initial settings are made. First, the work feeding device 68 is used to feed a master M to the work holder 22. After the master M has been fed, the air supply device 42 is driven to supply compressed air to the air supply passage 38 of the work holder 22. The supplied compressed air is spouted from the entire inner periphery to inner peripheral center of the work holder 22 via the nozzles 108, 108, . . . This centripetal action holds the master M in the inner peripheral center of the work holder 22.

For the master M fed to the work holder 22, predetermined size data has already been obtained, i.e., the outer diameter dimension D_{M}, the inner diameter dimension d_{M}, and the position of the outer diameter center O_{M} with respect to the inner diameter center I_{M} have already been measured.

Simultaneously with the feeding of the master M, the operator inputs the known size data D_{M}, d_{M}, and I_{M}(Δx, Δy) on the master from the keyboard 62. The inputted size data is stored in the memory contained in the arithmetic processing device 60.

When the predetermined size data is inputted, predetermined measurements are executed on the master M. Specifically, first, the control section 20 outputs a drive signal to the illuminating unit 56 to irradiate the end surface of the master M with illumination light. Further, the control section 20 outputs a drive signal to the AF driving unit 52 to subject the AF lens unit 50 to AF driving. Specifically, the AF lens unit 50 is subjected to AF driving so as to focus on the end surface of the master M held in the work holder 22. Then, the CCD camera 54 images the focused end surface of the master M.

The image processing device 58 executes image processing to determine an imaging scale Z for the image projected on the CCD according to an image of the inner diameter portion m of the master M projected on the CCD of the CCD camera 54 and the known size data (inner diameter dimension d_{M}) on the master M. The determined imaging scale Z is stored in the memory contained in the arithmetic processing device 60 as a constant.

Further, the image processing device 58 executes image processing to determine the position I_{M} of the inner diameter center of the master M on the CCD according to the image of the inner diameter portion m of the master M projected on the CCD.

Furthermore, the image processing device 58 executes image processing to determine the position of the outer diameter center O_{M} of the master M on the CCD according to the position I_{M} of the inner diameter center of the master M determined by image processing, the known size data (the position of the outer diameter center O_{M} with respect to the inner diameter center I_{M}), and the imaging scale Z. Then, the image processing device 58 sets X-Y coordinates (measurement coordinate system) on the CCD for which the determined position of the outer diameter center O_{M} of the master M is used as an origin O (0, 0).

Then, zero calibration and scale calibration are carried out for the outer diameter measuring section 100. The zero calibration and the scale calibration are executed using two masters M₁ and M₂ having different outer diameter dimensions. First, the master M₁ of a smaller diameter is fed to the work holder 22. The air supply device 42 is then driven, and the A/E converter 104 detects the change in backpressure. Then, in place of the master M₁ of the smaller diameter, the master M₂ of a larger diameter is fed to the work holder 22. The air supply device 42 is then driven, and the A/E converter 104 detects the change in backpressure. The changes in backpressure in the masters M₁ and M₂ detected by the A/E converter 104 are outputted to the arithmetic processing device 60 as electric signals. Then, according to the electric signals, the arithmetic processing device 60 makes scale setting and zero point setting for the outer diameter measuring section 100. Specifically, the arithmetic processing device 60 determines the relationship (backpressure characteristics) between changes in outer diameter dimension and changes in backpressure. The arithmetic processing device 60 also sets the backpressure in the master at a measurement reference value. In the measurements described below, the outer diameter dimension is calculated according to a comparison with the outer diameter dimension of the reference master.

Preferably, one of the two masters M₁ and M₂ is also used to set the origin of the above described measurement coordinate system. This allows the backpressure in one of the masters to be measured simultaneously with the operation of setting the origin of the above described measurement coordinate system.

The initial settings are thus completed. Once the initial settings are completed, the work collecting device 70 is used to collect the master M from the work holder 22. Then, comparative measurements are sequentially made using the master M as a reference.

First, the control section 20 outputs a drive signal to the work feeding device 68 to feed a work W to the work holder 22. After the work W has been fed, the air supply device 42 is driven to supply compressed air to the air supply passage 38 of the work holder 22. The supplied compressed air is spouted from the entire inner periphery to inner peripheral center of the work holder 22 via the nozzles 108. This centripetal action holds the work W in the inner peripheral center of the work holder 22.

Then, the CCD camera 54 images the image of the end surface of the work W held on the work holder 22. According to an image of the inner diameter portion w of the work W projected on the CCD of the CCD camera 54, the image processing device 58 executes image processing to determine the coordinate position (X_{I}, Y_{I}) of the inner diameter center I_{W} of the work W on the X-Y coordinates (measurement coordinates). Then, the image processing device 58 calculates the eccentricity ω according to the determined coordinate position (X_{I}, Y_{I}) of the inner diameter center I_{W} of the work W and the coordinate position (0, 0) of the origin O.

The image processing device 58 also executes image processing to determine the inner diameter dimension d_{W} of the work W according to the image of the inner diameter portion w of the work W projected on the CCD of the CCD camera 54 and the imaging scale Z.

Further, the arithmetic processing device 60 measures the outer diameter dimension D_{W} of the work W according to an electric signal for a change in backpressure outputted by the A/E converter 104. Specifically, the arithmetic processing device 60 calculates a difference from the outer diameter dimension D_{M} of the master M according to an electric signal for a change in the backpressure of air spouted from the inner periphery of the work holder 22. Then, according to the determined difference, the arithmetic processing device 60 calculates the outer diameter dimension D_{W} of the work W.

Thus, the size of the work W is completely measured. The measured size data, i.e., the inner diameter dimension d_{W}, outer diameter dimension D_{W}, and eccentricity ω of the work W, are displayed on the display 64 and also printed out by the printer 66 as required.

Further, when the measurements are finished, the control section 20 outputs drive signals to the switching device 72 and the work collecting device 70. The work W is classified and collected in the collecting stocker 90 according to the size data on the work W.

Once the work W is collected in the collecting stocker 90, a drive signal is outputted to the switching device 72 again to reconnect the work holder 22 to a different source. Then, the work feeding device 68 feeds a new work W to the work holder 22. The new work W is then similarly measured and collected.

Thus, the size measuring device according to the present embodiment enables the measurements of the outer diameter dimension D_{W} and inner diameter dimension d_{W} of the work W simultaneously with the measurement of the eccentricity ω.

Further, the outer diameter dimension D_{W} is measured using a change in the backpressure of air used to support the work W. Consequently, the whole device can be efficiently used.

In the present embodiment, the nozzle member 106 is used to spout air from the inner periphery of the work holder 22. However, the porous body 34 may be used to spout air as in the case with the first embodiment. Alternatively, the size measuring device 10 according to the first embodiment may use the nozzle member 106 to spout air from the inner periphery of the work holder 22 as in the case with the present embodiment. Further, if the nozzle member 106 is used, the number of nozzles 108 is not limited to four. At least three nozzles 108 have only to be formed.

Further, in the present embodiment, the outer diameter dimension of the work W is measured by detecting a change in the backpressure of air spouted from the inner periphery of the work holder 22. However, the outer diameter dimension of the work W may be measured by detecting a change in the flow rate of air spouted from the inner periphery of the work holder 22.

Now, description will be given of a third embodiment of a size measuring device according to the present invention.

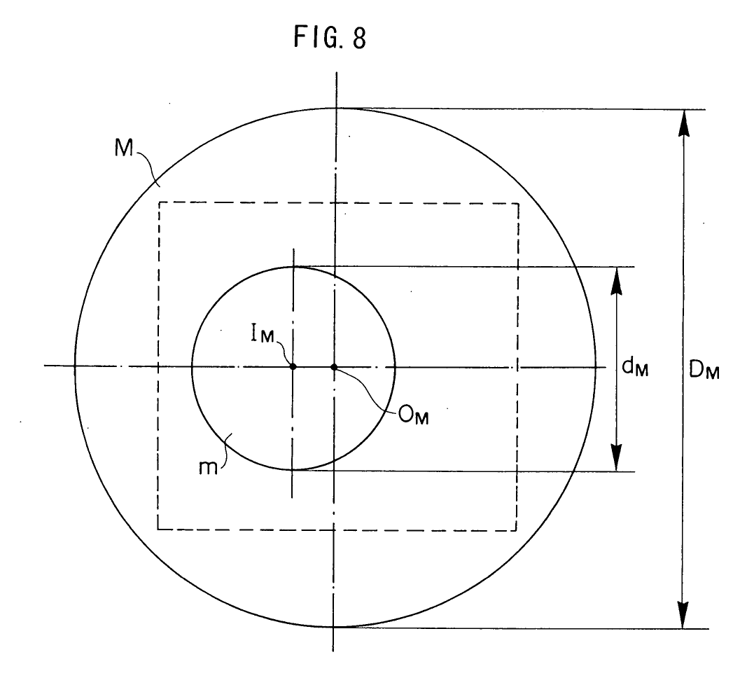

In the first embodiment, described above, the imaging scale and the origin of the measurement coordinate system are set using the master M the inner diameter dimension d_{M} of which is known and for which the position of the outer diameter center O_{M} with respect to the inner diameter dimension I_{M} is known. However, in the present embodiment, as shown in FIG. 8, the imaging scale and the origin of the measurement coordinate system are set using the master M the inner diameter dimension d_{M} of which is known (the eccentricity ω_{M}, the inner diameter dimension I_{M}, and the position of the outer diameter center O_{M} are unknown).

The configuration of the device and the measuring method for the work W are the same as those in the first and second embodiments except for the master M used. Accordingly, description will be given only of methods of setting the imaging scale and the measurement coordinate system.

First, the work holder 22 is supplied with a master M. The master M is housed in the inner periphery of the work holder 22 with its tip locked on the stopper plate 30. Then, the air supply device 42 is driven to supply compressed air to the air supply passage 38 of the work holder 22. This centripetal action holds the master M in the inner peripheral center of the work holder 22.

Here, the master M the outer diameter dimension D_{M} and inner diameter dimension d_{M} of which are known (the outer diameter dimension DM is not always required) is used as described above. The operator inputs the known size data D_{M} and d_{M} on the master from the keyboard 62. The inputted size data is stored in the memory contained in the arithmetic processing device 60.

When the predetermined size data is inputted, predetermined measurements are executed on the master M. Specifically, first, the control section 20 outputs a drive signal to the illuminating unit 56 to irradiate the end surface of the master M with illumination light. Further, the control section 20 outputs a drive signal to the AF driving unit 52 to subject the AF lens unit 50 to AF driving so that the AF lens unit 50 focuses on the end surface of the master M. Then, the CCD camera 54 images the image of the focused end surface of the master M.

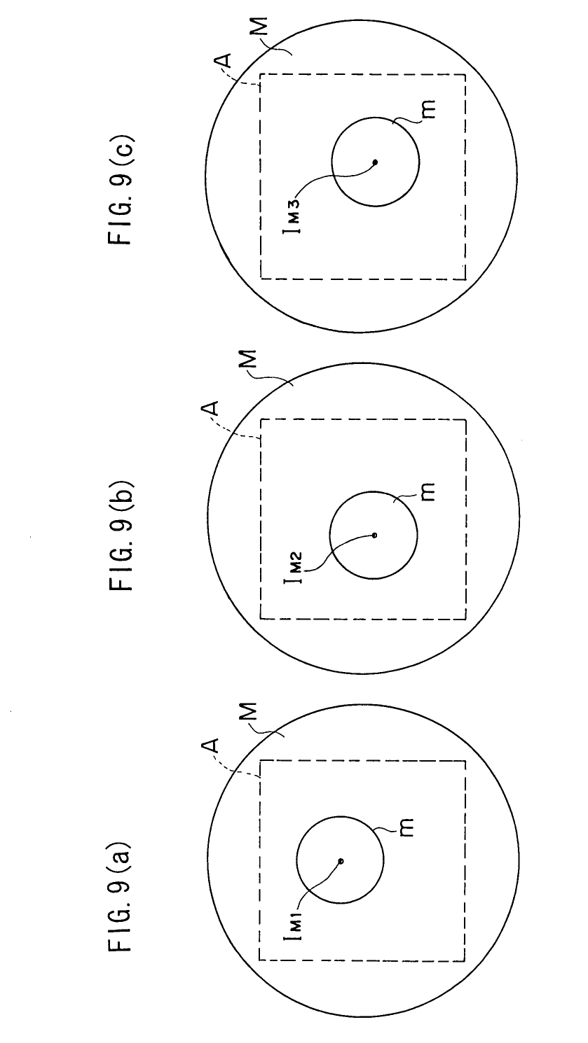

In this case, as shown in FIG. 9(a), a rectangular area A containing the inner diameter portion m of the master M is projected on the CCD of the CCD camera 54. The image processing device 58 executes image processing to determine the imaging scale Z for the image projected on the CCD according to an image of the inner diameter portion m of the master M projected on the CCD of the CCD camera 54 and the known inner diameter dimension d_{M} of the master M. The determined imaging scale Z is stored in the memory contained in the arithmetic processing device 60 as a constant.

Further, the image processing device 58 executes image processing to determine the position I_{M1} of the inner diameter center of the master M on the CCD according to the image of the inner diameter portion m of the master M projected on the CCD. The image processing device 58 then stores the determined position I_{M1} in the memory.

Then, the master M is removed from the work holder 22 and then fed back into the work holder 22. This causes the position of the inner diameter portion m of the master M held in the work holder 22 to shift in a circumferential direction as shown in FIG. 9(b). Then, the CCD camera 54 is used to image the end surface of the master M with the position of the inner diameter portion m shifted. The image processing device 58 executes image processing to determine the position I_{M2} of the inner diameter center of the master M on the CCD according to the image of the inner diameter portion m of the master M projected on the CCD. The image processing device 58 then stores the determined position I_{M2} in the memory.

After the second measurement of the position I_{M2} of the inner diameter center, the master M is removed from the work holder 22 again and then fed back into the work holder 22. This causes the position of the inner diameter portion m of the master M held in the work holder 22 to shift in the circumferential direction again as shown in FIG. 9(c). Then, the CCD camera 54 is used to image again the image of the end surface of the master M with the position of the inner diameter portion m thus shifted. The image processing device 58 executes image processing to determine the position I_{M3} of the inner diameter center of the master M on the CCD according to the image of the inner diameter portion m of the master M projected on the CCD. The image processing device 58 then stores the determined position I_{M3} in the memory.

As described above, when the master M is held in the work holder 22, the outer diameter center O_{M} is always held at the fixed position owing to the centripetal action of air. Accordingly, also on the CCD, the master M always has its outer diameter center O_{M} placed at a fixed position.

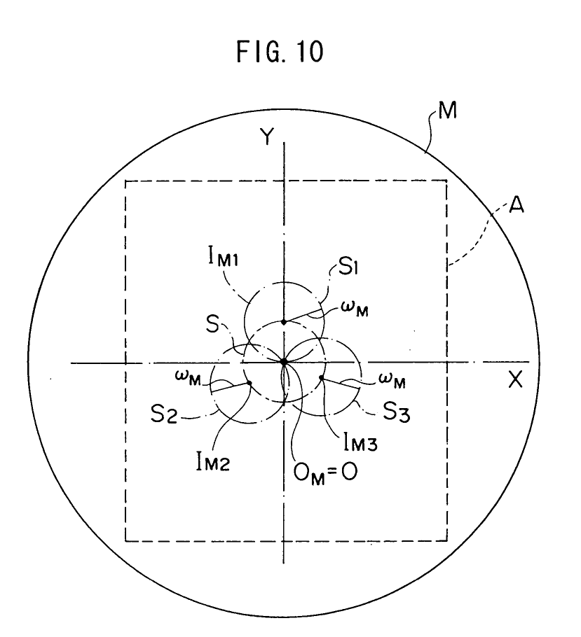

On the other hand, the eccentricity of the master M is invariable, so that provided that at least three positions of the inner diameter center I_{M} are determined, the position of the outer diameter center OM on the CCD can be identified by determining a point located at an equal distance from each of the determined inner diameter centers I_{M1}, I_{M2}, and I_{M3}. Specifically, as shown in FIG. 10, the outer diameter center O_{M} is located at an equal distance from each of the inner diameter centers I_{M1}, I_{M2}, and I_{M3}. Consequently, the position of the outer diameter center O_{M} can be identified by finding a circle S passing through the inner diameter centers I_{M1}, I_{M2}, and I_{M3} and then finding the center of the circle S.

The image processing device 58 determines the position O_{M} of the outer diameter center of the master M as described above. It then sets X-Y coordinates (measurement coordinate system) on the CCD for which the determined position of the outer diameter center O_{M} of the master M is used as an origin O (0, 0).

As described above, the imaging scale Z and the origin O of the measurement coordinate system can also be set using the master M only the inner diameter dimension d_{M} of which is known.

In the present embodiment, the master M is shaped like a cylinder. However, the master M may be a cylinder having a circular mark provided on its end surface.

Further, in the present embodiment, the position of the outer diameter center O_{M} is identified by finding a circle S passing through the inner diameter centers I_{M1}, I_{M2}, and I_{M3} and then finding the center of the circle S. However, if the eccentricity ω_{M} of the master M is known, the position of the outer diameter dimension O_{M} may be determined as described below, using the known eccentricity ω^{M}. Specifically, as shown in FIG. 10, the outer diameter center O_{M} is located at a distance ω_{M} (eccentricity) from each of the inner diameter centers I_{M1}, I_{M2}, and I_{M3}. Accordingly, the position of the outer diameter center O_{M} is determined by finding circles S₁, S₂, and S₃ of a radius ω^{M} centered at the inner diameter centers I_{M1}, I_{M2}, and I_{M3}, respectively, and finding a point at which all three circles S₁, S₂, and S₃ meet.

Now, description will be given of a fourth embodiment of a size measuring device according to the present invention.

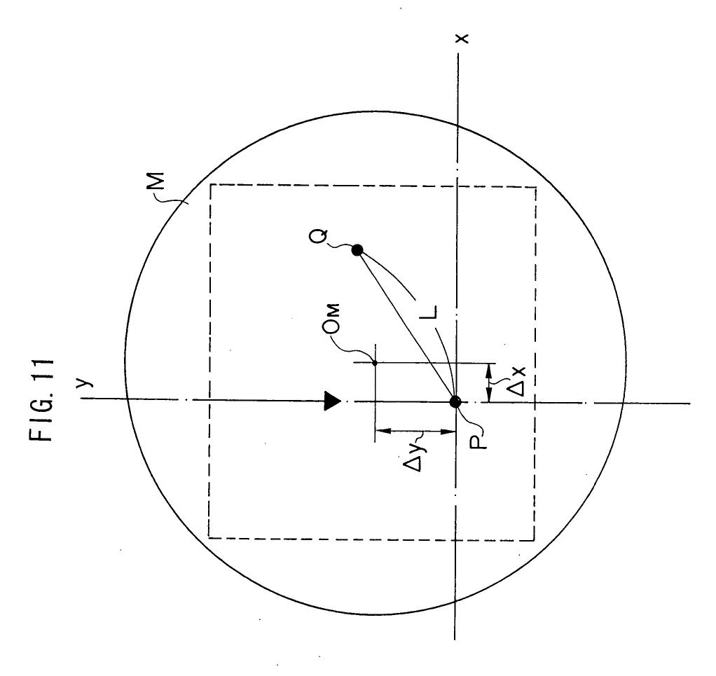

In the present embodiment, as shown in FIG. 11, the imaging scale and the origin of the measurement coordinate system are set using a cylindrical master which has two circular ( ) indices P and Q formed on its end surface and for which the distance L between the indices and the position of the outer diameter center O_{M} with respect to the index P are known.

The configuration of the device and the measuring method for the work W are the same as those in the first and second embodiments except for the master M used. Accordingly, description will be given only of methods of setting the imaging scale and the measurement coordinate system as in the case with the third embodiment, described above.

First, the work holder 22 is supplied with a master M. The master M is housed in the inner periphery of the work holder 22 with its tip locked on the stopper plate 30. Then, the air supply device 42 is driven to supply compressed air to the air supply passage 38 of the work holder 22. This centripetal action holds the master M in the inner peripheral center of the work holder 22.

Here, as described above, the master M which has two indices P and Q formed on its end surface, and for which the distance L between the indices and the position of the outer diameter center O_{M} with respect to the index P are known is used. The information on the position of the outer diameter center O_{M} with respect to the index P is obtained by setting x-y coordinates using the index P as a coordinate center (0, 0) on the end of the master and determining a coordinate position O_{M} (Δx, Δy) on the x-y coordinates. Further, a mark (in this case, a black triangular mark ▾) indicating the direction of a y axis for the set x-y coordinates is provided on the end surface of the master M.

Simultaneously with the feeding of the master M, the operator inputs the known size data L_{M} and O_{M} (Δx, Δy) on the master from the keyboard 62. The inputted size data is stored in the memory contained in the arithmetic processing device 60.

When the predetermined size data is inputted, predetermined measurements are executed on the master M. Specifically, first, the control section 20 outputs a drive signal to the illuminating unit 56 to irradiate the end surface of the master M with illumination light. Further, the control section 20 outputs a drive signal to the AF driving unit 52 to subject the AF lens unit 50 to AF driving so that the AF lens unit 50 focuses on the end surface of the master M held in the work holder 22. Then, the CCD camera 54 images the image of the focused end surface of the master M.

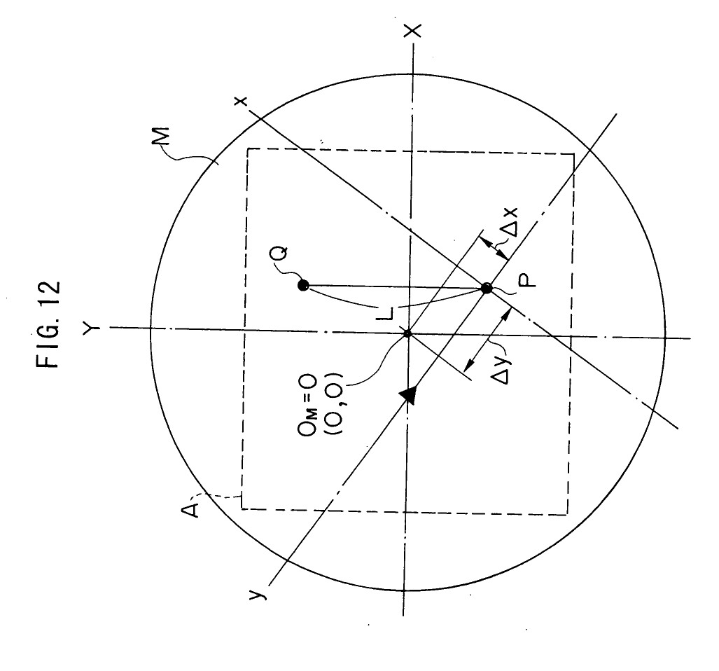

In this case, as shown in FIG. 12, a rectangular area A containing the indices P and Q formed on the end surface of the master M is projected on the CCD of the CCD camera 54. The image processing device 58 executes image processing to determine the imaging scale Z for the image projected on the CCD according to an image of the indices P and Q on the master M projected on the CCD of the CCD camera 54 and the known inter-index distance L of the master M. The determined imaging scale Z is stored in the memory contained in the arithmetic processing device 60 as a constant.

Further, the image processing device 58 executes image processing to determine the position of the outer diameter center O_{M} of the master M on the CCD according to the image of the indices P and Q on the master M projected on the CCD.

Furthermore, as shown in FIG. 12, the image processing device 58 executes image processing to determine the direction of the y axis for the x-y coordinates set on the end surface of the master M, from the position of the mark (▾) projected on the CCD and indicating the direction of the y axis. The image processing device 58 also executes image processing to determine the direction (passing through the index P and extending perpendicular to the y axis) of an x axis from the position of the index P. That is, the image processing device 58 executes image processing to determine the position of the x-y coordinates on the CCD which are set on the end surface of the master M.

Then, the image processing device 58 executes image processing to determine the position of the outer diameter center O_{M} of the master M on the CCD using the determined x-y coordinates on the CCD and according to the imaging scale Z, and the known size data (the position of the outer diameter center O_{M} with respect to the index P). Specifically, the x-y coordinates are set using the position of the index P on the master M as a coordinate center (0, 0), and the coordinate center O_{M}(Δx, Δy) of the outer diameter center O_{M} of the master M on the x-y coordinates is known. Thus, the image processing device 58 executes image processing to determine the position of the outer diameter center O_{M} of the master M on the CCD according to the imaging scale Z and the known size data.

The image processing device 58 sets X-Y coordinates (measurement coordinate system) on the CCD for which the determined position of the outer diameter center O_{M} of the master M is used as an origin O (0, 0).

In this manner, the imaging scale Z and the origin of the measurement coordinate system can also be set using the master according to the present invention.

In the present embodiment, the master M is shaped like a cylinder. However, the master M may be a cylinder having the indices P and Q formed on its end surface. Further, the shape of the indices P and Q is not limited to the circle ( ), but any other shape may be used as long as it allows the indices P and Q to be located.

Furthermore, at least two indices have only to be formed on the end surface of the master M. More indices may be formed.

Moreover, in the present embodiment, the direction of the y axis is identified using the mark ▾. However, the method for identifying the y coordinate is not limited to this aspect. Any other mark or the like may be used for the identification.

Now, description will be given of a fifth embodiment of a size measuring device according to the present invention.

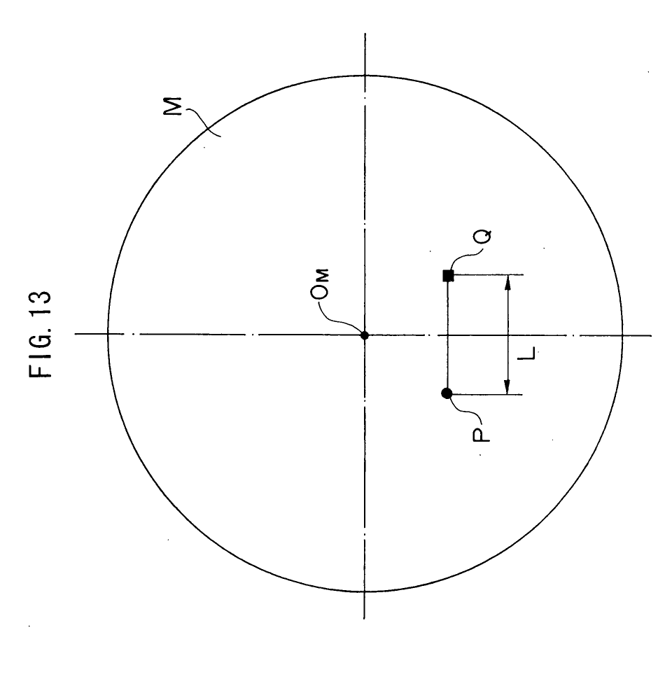

In the present embodiment, as shown in FIG. 13, the imaging scale and the origin of the measurement coordinate system are set using a cylindrical master which has two indices P (●) and Q (▪) formed on its end surface and for which the distance L between the indices is known.

The configuration of the device and the measuring method for the work W are the same as those in the first and second embodiments except for the master used. Accordingly, description will be given only of methods of setting the imaging scale and the measurement coordinate system as in the case with the third and fourth embodiments, described above.

First, the work holder 22 is supplied with a master M. The master M is housed in the inner periphery of the work holder 22 with its tip locked on the stopper plate 30. Then, the air supply device 42 is driven to supply compressed air to the air supply passage 38 of the work holder 22. This centripetal action holds the master M in the inner peripheral center of the work holder 22.

Here, as described above, the master M which has two indices P and Q formed on its end surface, and for which the distance L between the indices is known is used. The operator inputs the known inter-index distance L of the master from the keyboard 62. The inputted size data is stored in the memory contained in the arithmetic processing device 60.

When the predetermined size data is inputted, predetermined measurements are executed on the master M. Specifically, first, the control section 20 outputs a drive signal to the illuminating unit 56 to irradiate the end surface of the master M with illumination light. Further, the control section 20 outputs a drive signal to the AF driving unit 52 to subject the AF lens unit 50 to AF driving so that the AF lens unit 50 focuses on the end surface of the master M held in the work holder 22. Then, the CCD camera 54 images the image of the focused end surface of the master M.

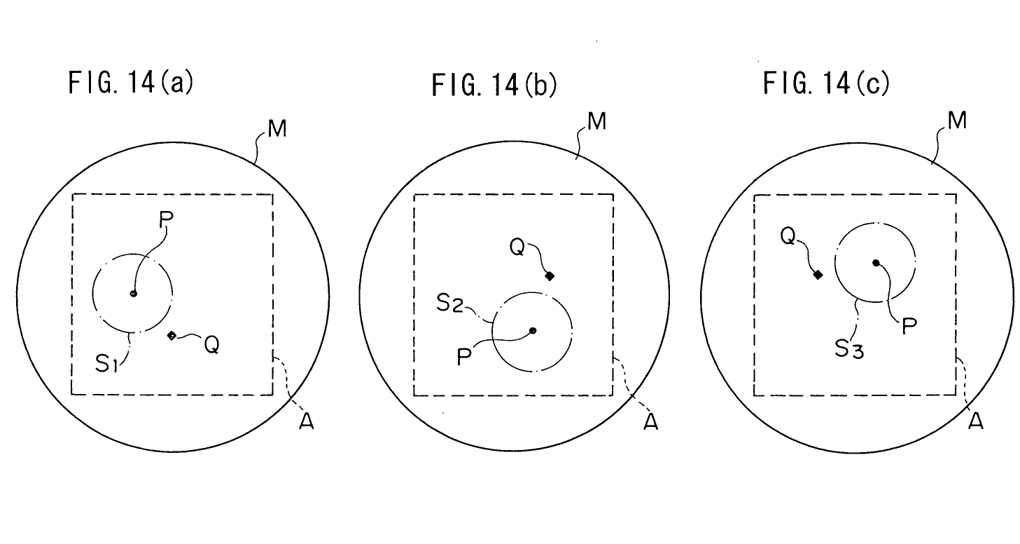

In this case, as shown in FIG. 14(a), a rectangular area A containing the indices P and Q is projected on the CCD of the CCD camera 54. The image processing device 58 executes image processing to determine the imaging scale Z for the image projected on the CCD according to an image of the indices P and Q on the master M projected on the CCD of the CCD camera 54 and the known inter-index distance L of the master M. The determined imaging scale Z is stored in the memory contained in the arithmetic processing device 60 as a constant.

Further, the image processing device 58 executes image processing to determine the position of the index P on the master M projected on the CCD. It then stored the determined position in the memory.

Then, the master M is removed from the work holder 22 and then fed back into the work holder 22. This causes the positions of the indices P and Q on the master M held in the work holder 22 to shift in the circumferential direction as shown in FIG. 14(b). Then, the CCD camera 54 is used to image the image of the end surface of the master M with the positions of the indices P and Q shifted. The image processing device 58 executes image processing to determine the position of the index P on the master M projected on the CCD. The image processing device 58 then stores the determined position in the memory.

After the second measurement of the position of the index P, the master M is removed from the work holder 22 again and then fed back into the work holder 22. This causes the positions of the indices P and M on the master M held in the work holder 22 to shift in the circumferential direction again as shown in FIG. 14(c). Then, the CCD camera 54 is used to image again the image of the end surface of the master M with the positions of the indices P and Q thus shifted. The image processing device 58 executes image processing to determine the position of the index P on the CCD according to the image of the indices P and Q projected on the CCD. The image processing device 58 then stores the determined position in the memory.

As described above, when the master M is held in the work holder 22, the outer diameter center O_{M} is always held at the fixed position owing to the centripetal action of air. Accordingly, also on the CCD, the master M always has its outer diameter center O_{M} placed at a fixed position.

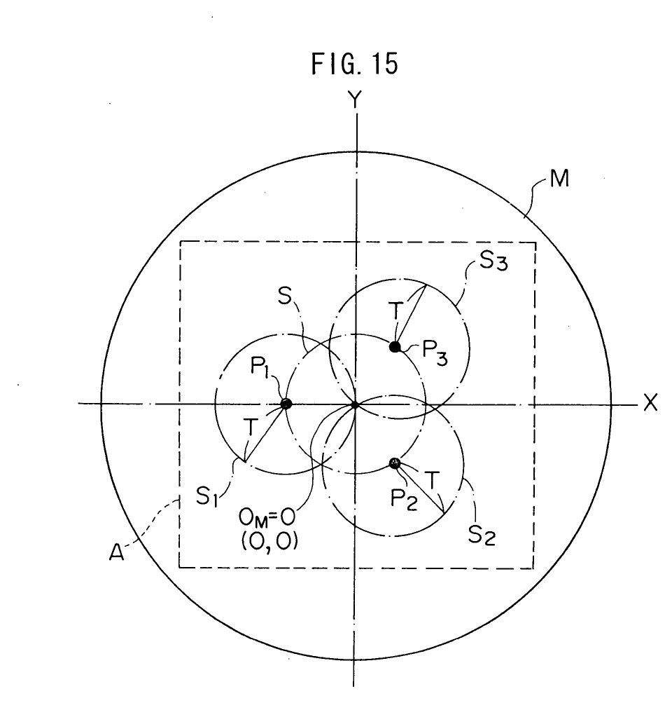

On the other hand, the distance between the outer diameter center O_{M} and the index P is invariable, so that provided that at least three positions of the index P are determined, the position of the outer diameter center O_{M} on the CCD can be identified by determining a point located at an equal distance from each of the determined positions of indices P₁, P₂, and P₃. Specifically, as shown in FIG. 15, the outer diameter center O_{M} is located at an equal distance from each of the indices P₁, P₂, and P₃. Consequently, the position of the outer diameter center O_{M} can be identified by finding a circle S passing through the indices P₁, P₂, and P₃ and then finding the center of the circle S.

The image processing device 58 determines the position O_{M} of the outer diameter center of the master M as described above. It then sets X-Y coordinates (measurement coordinate system) on the CCD for which the determined position of the outer diameter center O_{M} of the master M is used as an origin O (0, 0).

As described above, the imaging scale Z and the origin O of the measurement coordinate system can also be set using the master according to the present invention.

In the present embodiment, the master M is shaped like a cylinder. However, the master M may be a cylinder having the indices P and Q provided on its end surface. Further, the shape of the indices P and Q is not limited to the circle (●) or rectangle (▪), but any other shape may be used as long as it allows the indices P and Q to be located.

Further, in the present embodiment, the position of the outer diameter center O_{M} is identified by finding a circle S passing through the indices P₁, P₂, and P₃ and then finding the center of the circle S. However, if a distance T from the index P to the outer diameter center O_{M} of the master M is known, the position of the outer diameter dimension O_{M} may be determined using this known distance T. Specifically, as shown in FIG. 15, the outer diameter center O_{M} is located at the distance T from each of the indices P₁, P₂, and P₃. Accordingly, the position of the outer diameter center O_{M} is determined by finding circles S₁, S₂, and S₃ of a radius T centered at the indices P₁, P₂, and P₃, respectively, and finding a point at which all three circles S₁, S₂, and S₃ meet.

In the series of embodiments described above, the cylinders are measured. However, measurements are possible even if a cylinder is filled with another cylinder in its inner diameter portion. Accordingly, the work in the specification includes a work filled with a cylinder in its inner diameter portion or a cylinder with a circular mark provided on an end surface thereof.

Further, in the present embodiment, one master is used to set both the imaging scale Z and the origin O of the measurement coordinate system (=O_{M}). However, a master for setting the imaging scale and a master for setting the origin may be separately provided so that these two masters can be used to set the imaging scale Z and the origin O of the measurement coordinate system. Specifically, the master for setting the imaging scale is a cylindrical master having two indices P and Q on its end surface and the distance between the indices being known. The master for setting the origin of the measurement coordinate system is a cylindrical master with one index P on its end surface. These masters are provided and separately operated to set the imaging scale Z and the origin O of the measurement coordinate system.

In the present embodiment, the work holder 22 is installed in a vertical direction. However, similar effects can be produced by inclining the work holder 22. Even if the work holder 22 is installed in a horizontal direction, the work W can be pressed against the stopper plate 30 by the action of air spouted from the work holder 22 to hold the work W at a predetermined position, by supplying air with the shutter 78 of the feed pipe 76 shut and with the work holder 22 closed.

Further, in the present embodiments, measured works W are classified into OK and NG works. However, a plurality of stockers may be used to classify the OK works into further small ranks to carry out classification and collection.

A well-known image processing technique can be used to execute image processing to determine the diameter or central position of a circle in an image picked up by the CCD. Various image processing techniques can be used such as determination based on a contour, determination based on area center-of-gravity, and determination based on the midpoint of an X or Y dimension.

Further, in the present embodiment, the part (the triangular area A containing the inner diameter portion) of the end surface of the work or master is imaged, so that the eccentricity, the inner diameter dimension, or the like is determined according to the image data. However, the entire end surface of the work or master may be imaged so that the amount or the dimension is determined according to image data. The imaging scale can be increased by imaging a part of the end surface of the work or master as in the present embodiment. Accordingly, the work can be accurately measured even if the CCD has a smaller number of pixels.

### Industrial Applicability

As described above, according to the present invention, the size of a work can be measured without rotating the work. This eliminates the need for a mechanism for rotating the work. It is thus possible to provide a device having a simple and compact configuration. Further, since the work need not be rotated, it can be measured easily and promptly. Furthermore, the work is supported in a non-contact manner, thus preventing the work receiving member from being worn. Consequently, the device can always measure works stably accurately over time. Further, even if the outer periphery of the work is locally deformed, possible adverse effects can be eliminated to enable the work W to be always supported in the center of the work receiving member. Therefore, the work W can always be measured accurately.

1. A size measuring method, comprising:
a master imaging step of inserting, into a hole formed in a work receiving member, a cylindrical master an inner diameter dimension of which is known and for which a position of its outer diameter center with respect to its inner diameter center is known, spouting air from an inner periphery toward a center of the hole to support the master in the center of the hole, and using an imaging element to image an end surface of the master supported in the work receiving member;
an imaging scale calculating step of determining an imaging scale for an image projected on the imaging element from information on the known inner diameter dimension of the master according to an image of an inner diameter portion of the master projected on the imaging element;
a master inner diameter center position calculating step of determining a position of the inner diameter center of the master on the imaging element according to the image of the inner diameter portion projected on the imaging element;
an origin setting step of determining a position of the outer diameter center of the master on the imaging element according to information on the position of the inner diameter center of the master on the imaging element, on an imaging scale, and on the position of the outer diameter center with respect to the inner diameter center and setting the position of the outer diameter portion to be an origin on the imaging element;
a work imaging step of inserting a cylindrical master to be measured into a hole formed in the work receiving member, spouting air from the inner periphery toward the center of the hole to support the work in the center of the hole, and using the imaging element to image an end surface of the work supported in the work receiving member;
a work inner diameter center position calculating step of determining a position of an inner diameter center of the work on the imaging element according to an image of an inner diameter portion of the work projected on the imaging element; and
a work concentricity calculating step of determining concentricity of the work according to the position of the inner diameter center of work on the imaging element and the position of the origin set on the imaging element.

2. A size measuring method, comprising:
a master imaging step of inserting a cylindrical master an inner diameter dimension of which is known, into a hole formed in a work receiving member, spouting air from an inner periphery toward a center of the hole to support the master in the center of the hole, and using an imaging element to image an end surface of the master supported in the work receiving member;
an imaging scale calculating step of determining an imaging scale for an image projected on the imaging element from the information on the known inner diameter dimension of the master according to an image of an inner diameter portion of the master projected on the imaging element;
a master inner diameter center position calculating step of determining a position of the inner diameter center of the master on the imaging element according to the image of the inner diameter portion projected on the imaging element;
an origin setting step of determining a position of the outer diameter center of the master on the imaging element according to the imaging scale and a plurality of data on the position of the inner diameter center of the master on the imaging element obtained by repeating the master imaging step and the master inner diameter center position calculating step a number of times, and setting the position of the outer diameter portion to be an origin on the imaging element;
a work imaging step of inserting a cylindrical master to be measured into a hole formed in the work receiving member, spouting air from the inner periphery toward the center of the hole to support the work in the center of the hole, and using the imaging element to image an end surface of the work supported in the work receiving member;
a work inner diameter center position calculating step of determining a position of an inner diameter center of the work on the imaging element according to an image of an inner diameter portion of the work projected on the imaging element; and
a work concentricity calculating step of determining concentricity of the work according to the position of the inner diameter center of work on the imaging element and the position of the origin set on the imaging element.

3. A size measuring method, comprising:
a master imaging step of inserting, into a hole formed in a work receiving member, a cylindrical master which has two indices formed on its end surface and for which a distance between the indices and a position of its outer diameter center with respect to at least one of the indices are known, spouting air from an inner periphery toward a center of the hole to support the master in the center of the hole, and using an imaging element to image an end surface of the master supported in the work receiving member;
an imaging scale calculating step of determining an imaging scale for an image projected on the imaging element from the information on the known inter-index distance of the master according to an image of the indices projected on the imaging element;
an origin setting step of determining a position of the outer diameter center of the master on the imaging element according to information on a position of one of the indices on the imaging element, on the imaging scale, and a position of an outer diameter center with respect to the known index, and setting the position of the outer diameter portion to be an origin on the imaging element;
a work imaging step of inserting a cylindrical master to be measured into a hole formed in the work receiving member, spouting air from the inner periphery toward the center of the hole to support the work in the center of the hole, and using the imaging element to image an end surface of the work supported in the work receiving member;
a work inner diameter center position calculating step of determining a position of an inner diameter center of the work on the imaging element according to an image of an inner diameter portion of the work projected on the imaging element; and
a work concentricity calculating step of determining concentricity of the work according to the position of the inner diameter center of work on the imaging element and the position of the origin set on the imaging element.

4. A size measuring method, comprising:
a master imaging step of inserting, into a hole formed in a work receiving member, a cylindrical master which has two indices formed on its end surface and for which a distance between the indices is known, spouting air from an inner periphery toward a center of the hole to support the master in the center of the hole, and using an imaging element to image an end surface of the master supported in the work receiving member;
an imaging scale calculating step of determining an imaging scale for an image projected on the imaging element from the information on the known inter-index distance of the master according to an image of the indices projected on the imaging element;
a master index position calculating step of determining a position of one of the indices on the imaging element according to an image of the index projected on the imaging element;
an origin setting step of determining a position of the outer diameter center of the master on the imaging element according to a plurality of data on the position of the index on the imaging element obtained by repeating the master imaging step and the master index position calculating step a number of times and the imaging scale, and setting the position of the outer diameter portion to be an origin on the imaging element;
a work imaging step of inserting a cylindrical master to be measured into a hole formed in the work receiving member, spouting air from the inner periphery toward the center of the hole to support the work in the center of the hole, and using the imaging element to image an end surface of the work supported in the work receiving member;
a work inner diameter center position calculating step of determining a position of an inner diameter center of the work on the imaging element according to an image of an inner diameter portion of the work projected on the imaging element; and
a work concentricity calculating step of determining concentricity of the work according to the position of the inner diameter center of work on the imaging element and the position of the origin set on the imaging element.

5. The size measuring method as defined in claim 1, 2, 3 or 4, further comprising a work inner diameter dimension calculating step of determining the inner diameter dimension of the work according to an image of the inner diameter portion of the work projected on the imaging element.

6. The size measuring method as defined in claim 1, 2, 3, 4 or 5, further comprising:
a mater backpressure/flow rate measuring step of measuring a backpressure or flow rate of air spouted from the inner periphery of the hole in the work receiving member when the master is inserted;
a work backpressure/flow rate measuring step of measuring a backpressure or flow rate of air spouted from the inner periphery of the hole in the work receiving member when the work is inserted; and
a work outer diameter dimension calculating step of determining an outer diameter of the work according to the backpressure or flow rate of air spouted from the inner periphery of the hole in the work receiving member when the master is inserted, the backpressure or flow rate of air spouted from the inner periphery of the hole in the work receiving member when the work is inserted, and the known outer diameter dimension of the master.

7. A size measuring device, comprising:
a work receiving member having a hole into which is inserted a cylindrical work to be measured or a cylindrical master an inner diameter dimension of which is known and for which a position of its outer diameter center with respect to its inner diameter center is known;
an air spouting device which spouts air from an inner periphery toward a center of the hole in the work receiving member to support the work or master held in the work receiving member, in the center of the hole;
an imaging element which images an end surface of the master or work supported in the work receiving member;
an imaging scale calculating device which determines an imaging scale for an image projected on the imaging element from the information on the known inner diameter dimension of the master according to an image of an inner diameter portion of the master projected on the imaging element;
a master inner diameter center position calculating device which determines a position of the inner diameter center of the master on the imaging element according to the image of the inner diameter portion projected on the imaging element;
an origin setting device which determines a position of the outer diameter center of the master on the imaging element according to information on the position of the inner diameter center of the master on the imaging element, on an imaging scale, and on the position of the outer diameter center with respect to the inner diameter center, and sets the position of the outer diameter portion to be an origin on the imaging element;
a work inner diameter center position calculating device which determines a position of an inner diameter center of the work on the imaging element according to an image of an inner diameter portion of the work projected on the imaging element; and
a work concentricity calculating device which determines concentricity of the work according to the position of the inner diameter center of work on the imaging element and the position of the origin set on the imaging element.

8. A size measuring device, comprising:
a work receiving member having a hole into which is inserted a cylindrical work to be measured or a cylindrical master an inner diameter dimension of which is known;
an air spouting device which spouts air from an inner periphery toward a center of the hole in the work receiving member to support the work or master held in the work receiving member, in the center of the hole;
an imaging element which images an end surface of the master or work supported in the work receiving member;
an imaging scale calculating device which determines an imaging scale for an image projected on the imaging element from the information on the known inner diameter dimension of the master according to an image of an inner diameter portion of the master projected on the imaging element;
a master inner diameter center position calculating device which determines a position of the inner diameter center of the master on the imaging element according to the image of the inner diameter portion projected on the imaging element;
an origin setting device which determines a position of the outer diameter center of the master on the imaging element according to a plurality of data on the position of the inner diameter center of the master on the imaging element and the imaging scale, and sets the position of the outer diameter portion to be an origin on the imaging element;
a work inner diameter center position calculating device which determines a position of an inner diameter center of the work on the imaging element according to an image of an inner diameter portion of the work projected on the imaging element; and
a work concentricity calculating device which determines concentricity of the work according to the position of the inner diameter center of work on the imaging element and the position of the origin set on the imaging element.

9. A size measuring device, comprising:
a work receiving member having a hole into which is inserted a cylindrical master which has two indices formed on its end surface and for which a distance between the indices and a position of its outer diameter center with respect to at least one of the indices are known;
an air spouting device which spouts air from an inner periphery toward a center of the hole in the work receiving member to support the work or master held in the work receiving member, in the center of the hole;
an imaging element which images an end surface of the master or work supported in the work receiving member;
an imaging scale calculating device which determines an imaging scale for an image projected on the imaging element from the information on the known inter-index distance of the master according to an image of the indices projected on the imaging element;
an origin setting device which determines a position of the outer diameter center of the master on the imaging element according to information on a position of one of the indices on the imaging element, on the imaging scale, and a position of an outer diameter center with respect to the known index, and sets the position of the outer diameter portion to be an origin on the imaging element;
a work inner diameter center position calculating device which determines a position of an inner diameter center of the work on the imaging element according to an image of an inner diameter portion of the work projected on the imaging element; and
a work concentricity calculating device which determines concentricity of the work according to the position of the inner diameter center of work on the imaging element and the position of the origin set on the imaging element.

10. A size measuring device, comprising:
a work receiving member having a hole into which is inserted a cylindrical work to be measured or a cylindrical master which has two indices formed on its end surface and for which a distance between the indices is known;
an air spouting device which spouts air from an inner periphery toward a center of the hole in the work receiving member to support the work or master held in the work receiving member, in the center of the hole,
an imaging element which images an end surface of the master or work supported in the work receiving member;
an imaging scale calculating device which determines an imaging scale for an image projected on the imaging element from the information on the known inter-index distance of the master according to an image of the indices projected on the imaging element;
a master index position calculating device which determines a position of one of the indices on the imaging element according to an image of the index projected on the imaging element;
an origin setting device which determines a position of the outer diameter center of the master on the imaging element according to a plurality of data on the position of the index on the imaging element and the imaging scale, and sets the position of the outer diameter portion to be an origin on the imaging element;
a work inner diameter center position calculating device which determines a position of an inner diameter center of the work on the imaging element according to an image of an inner diameter portion of the work projected on the imaging element; and
a work concentricity calculating device which determines concentricity of the work according to the position of the inner diameter center of work on the imaging element and the position of the origin set on the imaging element.

11. The size measuring device as defined in claim 7, 8, 9 or 10, wherein the air spouting device comprises a plurality of nozzles disposed in the inner periphery of the hole in the work receiving member at predetermined intervals.

12. The size measuring device as defined in claim 7, 8, 9 or 10, wherein the air spouting device spouts air from the entire inner periphery toward the center of the hole via a porous body disposed in the inner periphery of the hole in the work receiving member.

13. The size measuring device as defined in claim 7, 8, 9, 10, 11 or 12, wherein the size measuring means comprises:
a work feeding device which feeds a work to be measured to the hole in the work receiving member; and
a work collecting device which collects the measured work from the hole in the work receiving member.

14. The size measuring device as defined in claim 13, wherein the work collecting device comprises a classifying device which carries out classification and collection according to results of measurements.
